(19) United States
(12) Patent Application Publication
(10) Pub. No.: US 2008/0245794 A1
(43) Pub. Date: Oct. 9, 2008

(54) Trash can pedals

(76) Inventors: Juan C. Escobar, New York, NY (US); Ryan Vernon, New York, NY (US)

Correspondence Address: SEYFARTH SHAW LLP, 131 S. DEARBORN ST., SUITE 2400, CHICAGO, IL, 60603-5803, US

(21) Appl. No.: 12/080,664

(22) Filed: Apr. 4, 2008

Related U.S. Application Data
(60) Provisional application No. 60/922,001, filed on Apr. 5, 2007.

(51) Int. Cl. B65F 1/14; B65F 1/00; B65D 43/26

(52) U.S. Cl. 220/263; 206/518

(57) ABSTRACT

A trash can having a foot pedal for actuating a lid atop the trash can into an open position. The foot pedal may be either retractable or foldable to provide a small footprint for boxing and to allow multiple trash cans to be stacked one inside another. The stackability provides several cans to be packaged together in shipment to retailers. The retractable or foldable foot pedal allows the retailer and end user to easily display or use the can without the need of tedious construction of the foot pedal.

### RELATED APPLICATIONS

The present application claims priority of U.S. Provisional Application Ser. No. 60/922,001, filed Apr. 5, 2007, the entire disclosure of which is hereby incorporated by reference.

### TECHNICAL FIELD OF THE INVENTION

The present device relates to trash cans. Particularly, the present device relates to trash cans having foot pedal operation to actuate a hinged lid.

### BACKGROUND OF THE INVENTION

Trash cans have been around for quite some time. Innovations on this basic concept of retaining waste illustrate the concern for both the home and the workplace in containing and holding trash until permanent disposal is possible. Because these devices are prevalent in just about every typical home and office, the need to control odor and the unsightliness of the trash became a concern. To solve this problem, trash and garbage cans often employ lids and covers to contain the trash and its associated odor, to hide the trash from view, and to prevent the trash from contaminating areas beyond the lid.

Improvements over the years have been directed to making the covered trash cans more user-friendly, sanitary, and hygienic. For example, trash cans are now provided with a foot pedal positioned adjacent the base of the trash can so that a user can step on the foot pedal to open the lid of the trash can, thereby freeing up the user's hands to toss trash, or to change the plastic liner or bag that is used to line the trash can. This feature also negates the need of the user to handle the trash can lid, which can be a source of contamination.

The conventional foot pedal usually is recessed in an opening within the footprint of the can body or extends from the body of the trash can. The former case makes the pedal less accessible to user. The latter configuration has two immediate drawbacks.

First, as a result of the outwardly extending foot pedal, the containing boxes used to store the trash can must be provided in a larger size so that the foot pedal can fit within the box. Given the fact that some of these trash cans can be quite large, any small increase in the size of the containing box would significantly increase storage and transportation costs.

Second, there are some retailers who prefer to sell two or more trash cans (of different sizes) together. However, the extending foot pedals would prevent the trash cans from being nested inside each other, so that the containing box or packaging must accommodate two or more trash cans positioned side by side. This means that the packaging or box must be extremely large, thereby prohibitively increasing the storage and transportation costs.

Removable foot pedals have been tried, but this requires construction by the retailer for display and/or the purchaser. This is undesirable for many such users.

Accordingly, there remains a need for a trash can assembly that overcomes the drawbacks outlined above.

### SUMMARY OF THE INVENTION

There is disclosed herein an improved trash can which avoids the disadvantages of prior devices while affording additional structural and operating advantages.

A trash can is described comprising a container having an open end for receiving and an outer periphery for retaining discarded trash, a lid covering the open end of the container, a lifting mechanism for raising the lid to expose the container opening, and a foot pedal coupled to the lifting mechanism, wherein the foot pedal is configured to be stored when desired in a manner such that the foot pedal does not extend beyond the periphery of the container.

It is an aspect of the invention to provide a foot pedal which can be folded into a recess of the trash can to allow stacking of multiple cans.

It is also an aspect of the invention to provide a foot pedal which can be telescopically retracted into a recess, or a rocker assembly, of the trash can to allow stacking of multiple cans.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an embodiment of the present trash can illustrating a foot pedal in an extended position;

FIG. 2 is a perspective view of the embodiment of FIG. 1 illustrating the foot pedal in a up-folded position;

FIG. 3 is a cross-section of an embodiment of the present trash can showing the folding foot pedal;

FIG. 4 is a cross-section of several cans in a stacked arrangement, each with a folded foot pedal;

FIG. 5 is a cross-section of an embodiment of a folding foot pedal in a stacked arrangement;

FIG. 6 is a perspective view showing an embodiment of the folding foot pedal of the present invention;

FIG. 7 is a perspective view of an embodiment of the present trash can illustrating a foot pedal in an extended position;

FIG. 8 is a perspective view of the embodiment of FIG. 5 illustrating the foot pedal in a retracted position;

FIG. 9 is a cross-section of an embodiment of the present trash can showing the telescopically retracting foot pedal; and

FIG. 10 is a cross-section of several cans in a stacked arrangement, each with a retracted foot pedal.

### DETAILED DESCRIPTION Of PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

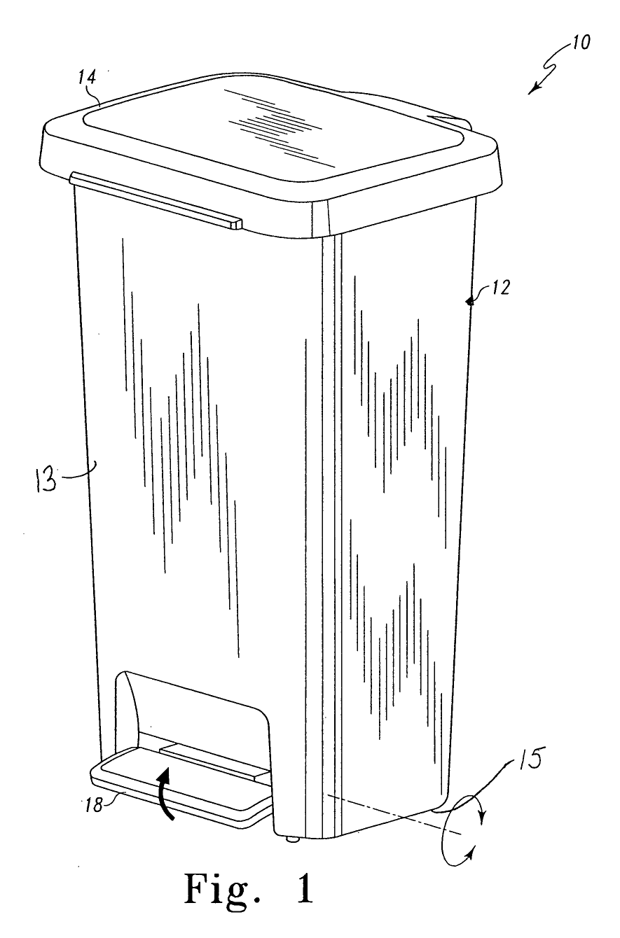

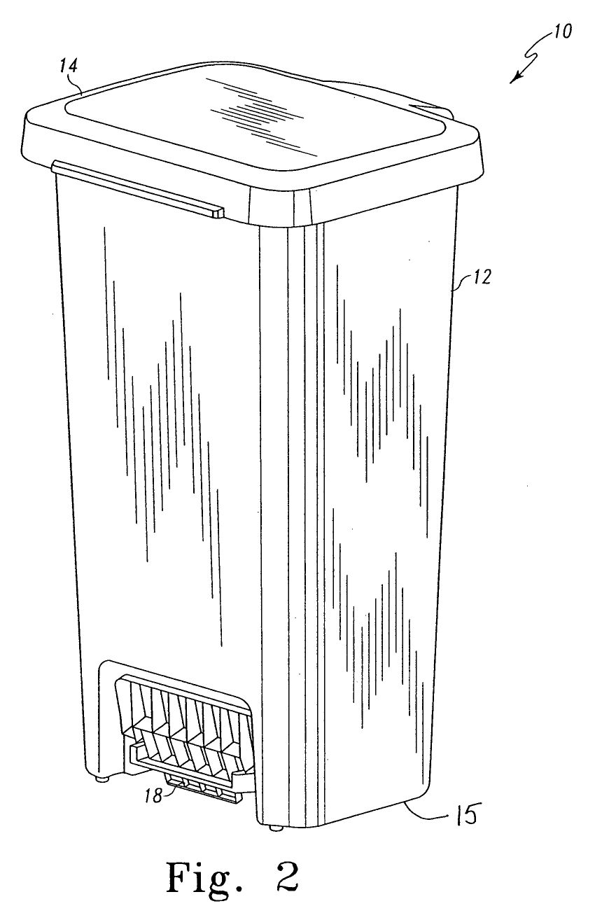

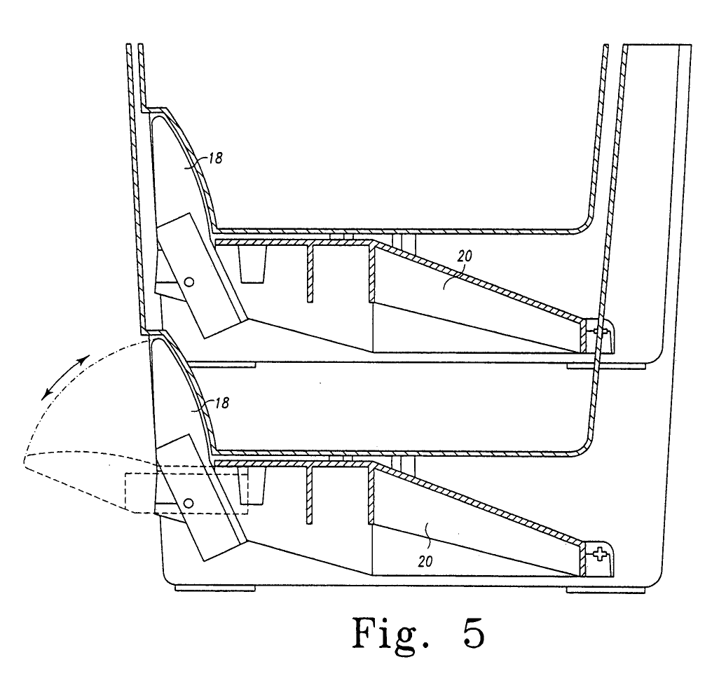

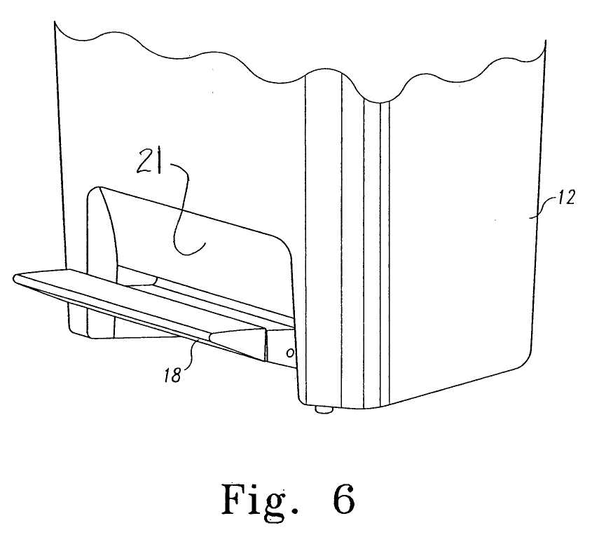

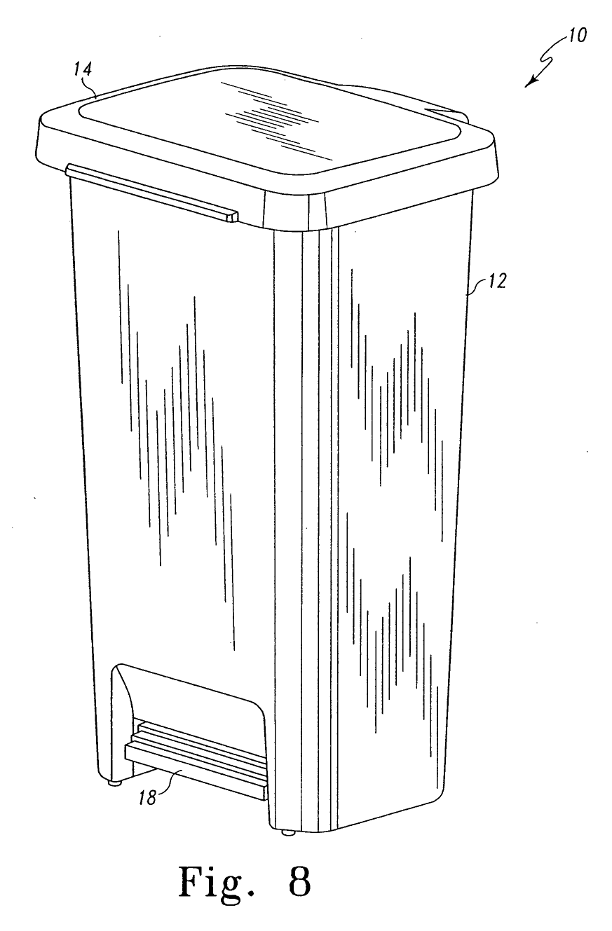

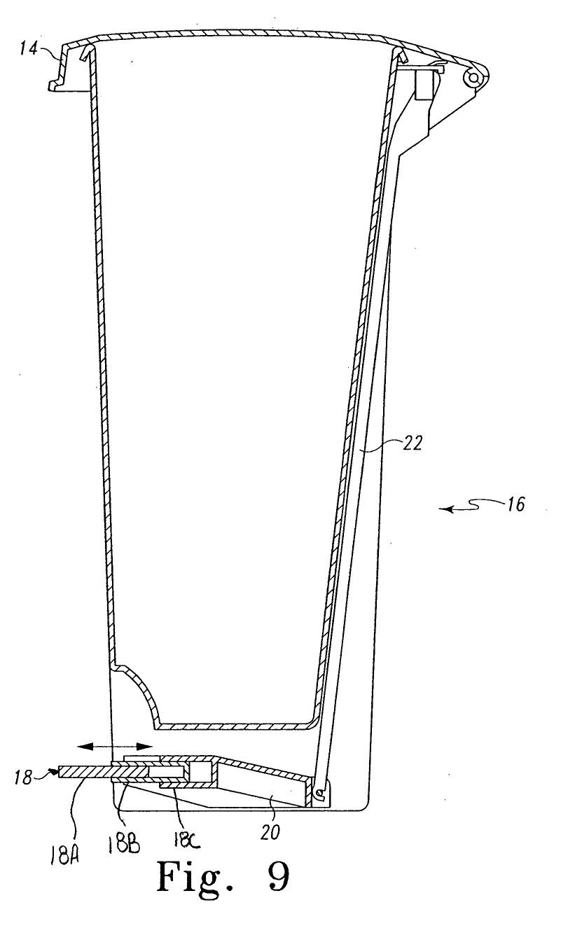

Referring to FIGS. 1-10, there is illustrated a trash can, generally designated by the numeral 10. The trash can 10 is of the variety which possess a foot pedal which can be stepped on to actuate a rocker mechanism coupled to the lid. The force placed on the foot pedal ultimately opens the lid. Accordingly, the disclosed trash can 10 has a container 12 defined by sidewalls 13 and a closed bottom surface 15, a lid 14, a lifting mechanism 16, and a foot pedal 18 coupled to the lifting mechanism 16.

The container 12 may come in any number of shapes and sizes, as is well-known in the art. Typically, the container 12 includes a base 17 having the closed bottom surface 15 and a channel for securing the foot pedal 18 and lifting mechanism 16. The sidewall 13 of the container 12 is preferably tapered, even slightly, from top to bottom, to allow nesting of multiple containers 12. Thermoplastics such as polypropylene and ABS plastic, and including thermoset and thermoform materials are preferred for most components of the present invention.

Similarly, the lid 14, which is used to cover an open end of the container 12, should be sized and shaped to completely cover the open end of the container 12. The lid 14 may be single component, as shown in the drawing figures, or it may include a two-part bezel-and-cover (not shown), where the cover, being hinged to the bezel, may be raised separate from the bezel itself, which would be hinged to the container. Other well-known configurations are also possible.

The lid 14 is, of course, preferably hinged to the container 12 in a manner which permits pivoting of the lid 14 at the hinge to expose the open end of the container 12 when desired. The lid 14 may be configured to be seated at the container opening in any number of different ways. However, the lid 14 should be lightweight so as not to require a significant force to lift.

The lifting mechanism 16 preferably comprises a rocker assembly 20 within the base 17 of the container 12 and linkage 22 coupling the rocker assembly 20 to the lid 14. As the foot pedal 18 is depressed, the rocker assembly 20 pivots downward at the end coupled to the foot pedal 18 and upward at the opposite end, which is coupled to the linkage 22. The linkage 22 travels along a backside of the trash can 10 where it contacts the lid 14. The linkage 22 is moved upward with the pivoting rocker assembly 20 and the contacting end pushes upward on the lid 14. The mechanics of this system are well-understood by those skilled in the art.

The foot pedal 18 is permanently or removably connected to the rocker assembly 20 at the base of the container 12. As previously explained, depressing the foot pedal 18 results in operation of the lifting mechanism 16, via the rocker assembly 20, to lift the non-hinged side of the lid 14. The lifting mechanism 16 may operate to either push upward on the lid 14 or with modifications, it can pull downward on a back portion of the lid 14 to thereby open the lid 14. Many other variations may be made to the specific components without departing from the intended scope of the present invention.

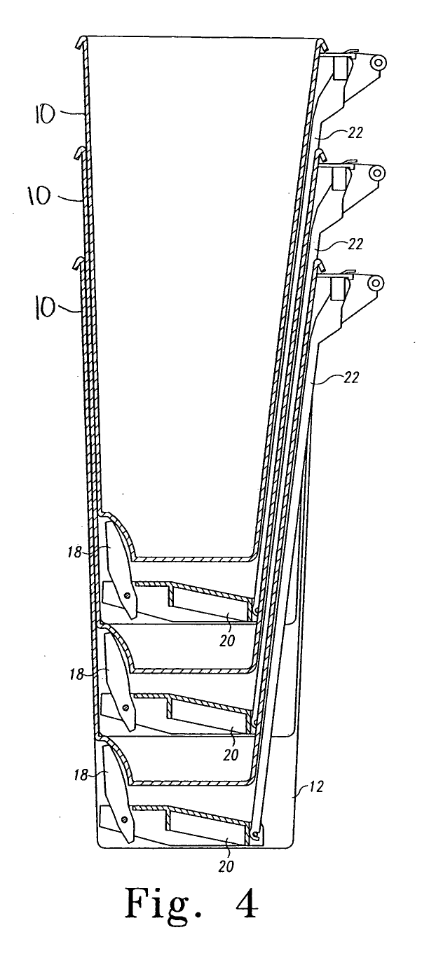

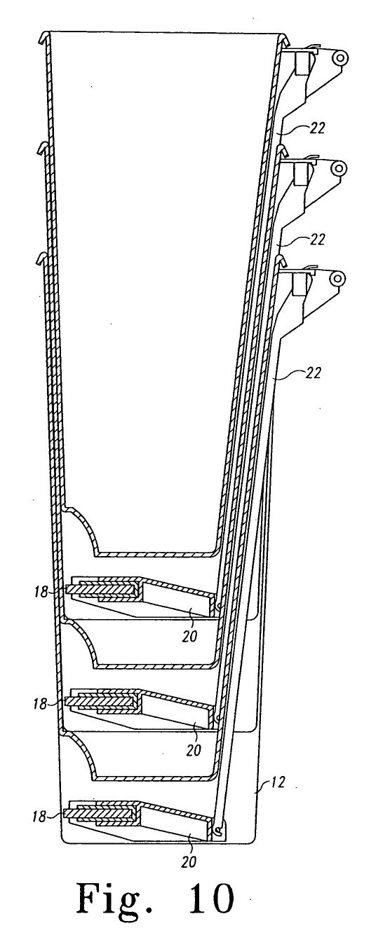

A key aspect of the invention is that the foot pedal 18 is configured to be stored, when desired, in a manner such that the foot pedal 18 does not extend beyond the periphery of the container 12. As shown in the several figures, the foot pedal 18 may either fold into a recess disposed within the sidewall 13 of the container 12, or it may be telescopically retracted into a recess in the base of the container 12 or into the rocker assembly 20. Stowing the foot pedal 18 allows the trash can 10 to be (1) placed into a box having a smaller footprint for shipment or retail display, and (2) stacked in a nesting arrangement, as shown in FIGS. 4 and 10.

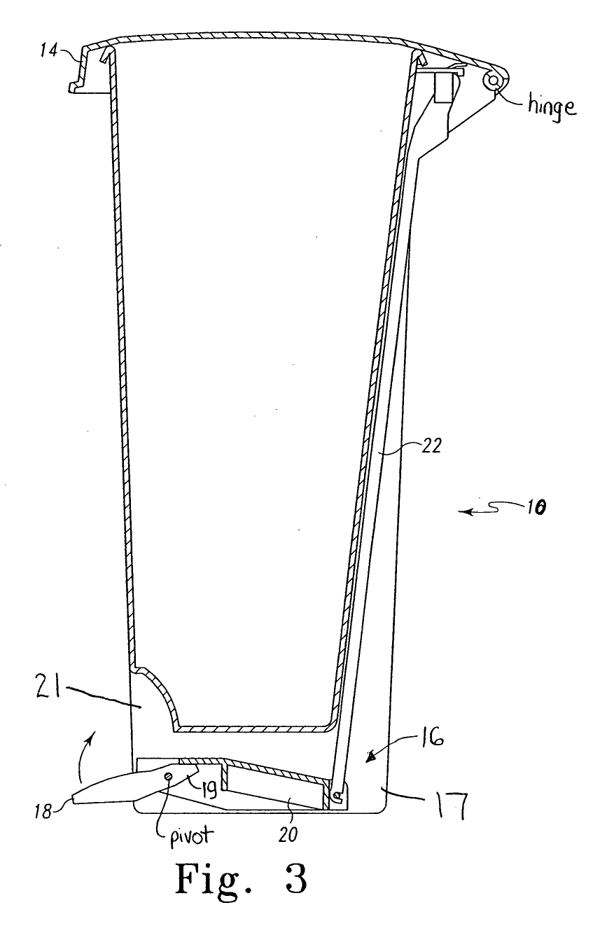

In one embodiment, the folding foot pedal 18 shown in FIGS. 1-6, is hinged at the rocker assembly 20 to allow the foot pedal 18 to fold upward into a recess 21. The upward pivot of the foot pedal 18 may be done manually or automatically as a result of boxing or nesting a trash can 10 within another. The pedal 18 may fall back into a horizontal configuration when a can is unboxed or unnested, or a simple locking feature (not shown) may be used to retain the folded pedal 18 in the recess 21 until manually lowered. As shown in FIG. 3, a back portion 19 of the foot pedal 18 abuts an inside surface of the rocker assembly 20 to prevent further rotation of the foot pedal 18.

If desired, a downward fold may be achievable, but would require a locking feature (not shown) to retain a horizontal configuration for normal use. For example, aligning holes in the foot pedal and the rocker assembly can be held with the insertion of a pin. Other locking configurations are certainly possible.

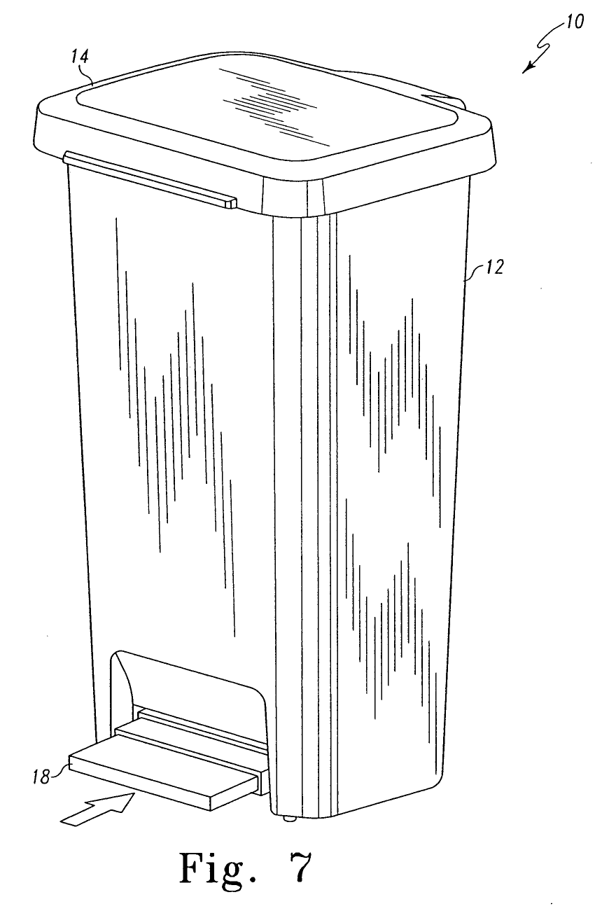

In an embodiment of the telescoping foot pedal, as shown in FIGS. 7-10, the pedal is comprised of three sections 18A-C. Extended, the three sections 18A-C may lock to one another to present a usable foot pedal 18. However, as needed, for boxing a can or nesting multiple trash cans for example, the three sections 18A-C may be retracted, as shown. The number of retractable sections may vary, having as few as a single section which retracts into, for example, the rocker assembly. Other configurations may be possible, and are considered to fall within the scope of the present claims.

Preferably, the container 12 should be stackable and nestable with the pedal 18 attached and the pedal configuration should be operable at retail. It is also preferred that the stacking of the trash can 10 should maintain about four inches (4″) distance between the tops of consecutive cans. For example, it would be possible to stack three (3) cans 10 in an approximate box having dimensions of approximately 34″×16″×15.2″(h×w×d).

The trash can 10 may include numerous other features, not shown-e.g., a bag lock, a stay-open lid, a wide pedal, etc. It is preferred that the can 10 be sized to fit appropriate and existing trash bags. Construction of the trash can 10 should be less labor intensive as compared to prior art cans by utilizing snap connectors rather than the traditional screw connectors.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A trash can having an step pedal-operated cover, said trash can comprising:
a container sidewall and bottom surface, collectively defining an interior space for collecting discarded material from an open end;
a hinged cover having a first closed position blocking the open end and a second open position exposing the open end;
a foot pedal hingeably connected adjacent the bottom surface; and
a linking mechanism contacting at one end the foot pedal and at an opposite end the cover;
wherein with the application of a force, the foot pedal moves between a first position and a second position to thereby move the cover between the first closed position and the second open position via the linking mechanism, and wherein the foot pedal moves to a third position without disconnecting from adjacent the bottom surface.

2. The trash can of claim 1, further comprising a recess within the container sidewall and wherein the third position of the foot pedal resides within the recess.

3. The trash can of claim 2, wherein the foot pedal folds into the recess.

4. The trash can of claim 1, further comprising a recess adjacent the bottom surface wherein the third position of the foot pedal resides within the recess.

5. The trash can of claim 4, wherein the foot pedal retracts into the recess.

6. The trash can of claim 1, wherein the foot pedal is comprised of telescoping sections.

7. The trash can of claim 1, wherein the foot pedal does not extend beyond an outer periphery of the sidewall when in the third position.

8. The trash can of claim 1, wherein the foot pedal moves to a third position to allow nesting of a plurality of trash cans.

9. The trash can of claim 1, wherein the foot pedal moves to a third position to allow reduction of a footprint of the trash can.

10. A trash can comprising:
a container having an open end for receiving and an outer periphery for retaining discarded trash;
a lid covering the open end of the container;
a lifting mechanism for raising the lid to expose the container opening;
a foot pedal coupled to the lifting mechanism, wherein the foot pedal is configured to extend beyond the container periphery for better access during use and can be stored when desired in a manner such that the foot pedal is not removed and does not extend beyond the periphery of the container.

11. The trash can of claim 10, further comprising a recess within the container proximate the foot pedal.

12. The trash can of claim 11, wherein the foot pedal folds into the recess.

13. The trash can of claim 11, wherein the foot pedal telescopically retracts into the recess.

14. The trash can of claim 10, further comprising a rocker assembly for coupling the foot pedal to the lifting mechanism.

15. The trash can of claim 14, wherein the foot pedal is hingably attached to the rocker assembly.

16. The trash can of claim 15, wherein the foot pedal is telescopically retractable into the rocker assembly.

17. The trash can of claim 10, wherein a plurality of trash cans can be nested within one another when the foot pedal is stored.

18. The trash can of claim 10, wherein the trash can has a reduced footprint when the foot pedal is stored.
